(19) United States
(12) Patent Application Publication
(10) Pub. No.: US 2004/0045397 A1
(43) Pub. Date: Mar. 11, 2004

(54) Anti-vibration method for rotating disks and its apparatus

(76) Inventor: Sean Chang, Taoyuan (TW)

Correspondence Address: BIRCH STEWART KOLASCH & BIRCH, PO BOX 747, FALLS CHURCH, VA, 22040-0747, US

(21) Appl. No.: 10/336,018

(22) Filed: Jan. 3, 2003

(30) Foreign Application Priority Data
Sep. 11, 2002 (TW) 091120776

(51) Int. Cl. F16F 15/22

(52) U.S. Cl. 74/573 R

(57) ABSTRACT

This invention provides an anti-vibration method for rotating disks and its apparatus for color wheel modules. It effectively eliminates vibration of a rotating disk due to unbalance. The method involves filling a curable fluid in a holder of the rotating disk. When the disk rotates, the curable fluid flows to balance the disk, and the fluid is then hardened at this balance position. As a result, it can effectively eliminate vibration of a rotating disk, such as a color wheel module.

### FIELD OF THE INVENTION

The present invention relates to an anti-vibration method for rotating disks and its apparatus adopted for use on rotating disks such as color wheel modules, and more particularly, to a method and apparatus that employs curable fluid to eliminate vibration generated by a rotating disk.

### BACKGROUND OF THE INVENTION

In theory, a rotating disk may rotate about the rotational spindle in a steady and balanced manner. However, in practice, due to inherent manufacturing defects or assembly problems, the substance of the rotating disk does not evenly distribute. As a result, vibration occurs when the rotating disk rotates. Although the vibration amplitude might not be significant in some circumstances, with precise optical instruments it becomes a critical factor whether the required precision level can be achieved.

Take the color wheel module for example. Color wheel modules have been widely used in picture display devices. The color wheel consists of a plurality of colored filter films bonding together. Its rotation modulates the color of the incident light to provide light beams with the sequential color changed at a rapid frequency so that the picture display device can produce the required picture formation. As the color wheel switches the color of the incident light through rotation, balance becomes an important issue.

Conventional balance methods mostly try to determine the unbalanced location through actually driving a disk 11. As shown in FIG. 1A, the disk 11 is driven to rotate by a motor 12. Because the unbalance substance M of the disk generates a centrifugal force during rotating, the centrifugal force incurs vibration. A sensor such as an accelerometer may be used to detect the amplitude and phase angle of the vibration. Based on the vibration amplitude and phase angle, the unbalance substance M and its phase angle θ may be determined. Moreover, in order to avoid interference caused by the mounting plane such as the table top which the disk 11 is driven, the disk 11 and the motor 12 may be mounted onto a suspending surface 13 supported by springs 14.

Refer to FIG. 1B for calculating the unbalance condition. When the unbalance substance M and the phase angle of a disk 11 are known, there are two common approaches to remedy the problem, i.e. adding or removing the corresponding substance. Manufacturers may choose to add a corresponding substance on a location 180 degrees against the unbalance substance M to eliminate the vibration. It is also possible to remove a corresponding substance on the location of the unbalance substance M to eliminate the vibration. However, in practice, the location and amount of the unbalance substance M cannot be calculated as accurately as desired. In most circumstances, only proximate values are obtained. Then trial and error approaches are taken to perform correction. For instance, a drill out method may be taken to remove the substance. When the unbalance substance M of the disk 11 is obtained, a small hole may be drilled on the location where the unbalance substance M is positioned to remove a selected amount of substance. Then a test run is taken. If the result is not satisfactory, another small hole is drilled. In the event that too many holes are drilled on one side, a small hole is drilled on the diagonal side. The process is repeatedly performed until the disk 11 is balanced. Such a balance method is inefficient. Even the final balance attained is not totally desirable. It can only reach a balance within the range of tolerances of measurement and calculation.

### SUMMARY OF THE INVENTION

The primary object of the invention is to resolve the foregoing disadvantages. The present invention provides an anti-vibration method for rotating disks and its apparatus for eliminating vibration of color wheel modules and rotating disks so that they may be freed from vibration caused by unbalance during a rotation process.

The anti-vibration method for rotating disks and apparatus of the present invention includes a holder formed on a rotating disk to contain curable fluid. When the rotating disk rotates, the fluid will automatically flow to and distribute on balanced positions due to the vibration force. Then the fluid is curdled and solidified. Thus, balance can be reached for the rotating disk. The flowage of the fluid is done due to the vibration so that the fluid will keep floating until the vibration is gone. Such a method and structure is not only easier to implement, it also can attain more precise balance.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of a conventional structure for measuring unbalance conditions of a rotating disk.

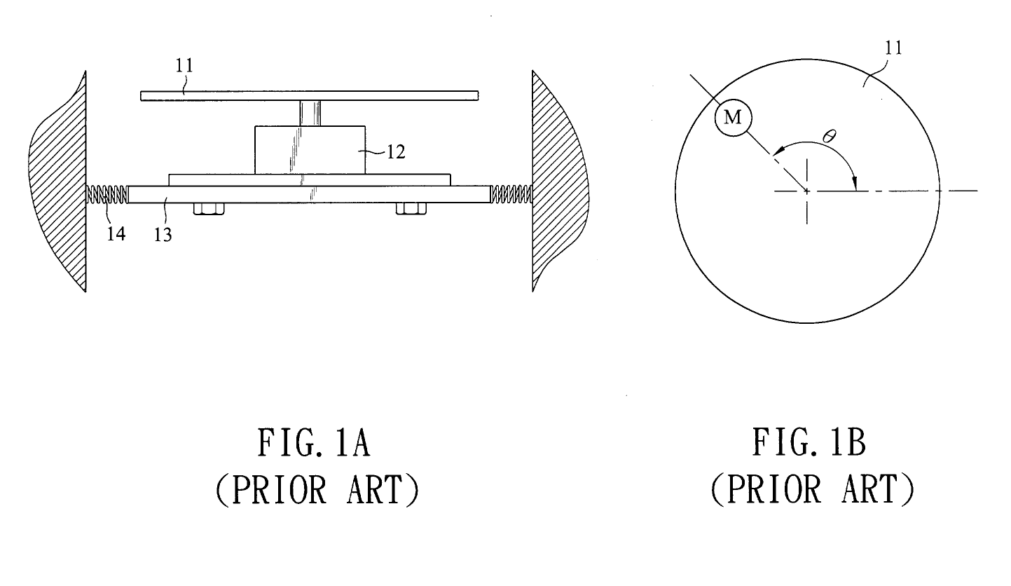

FIG. 1B is a schematic view of a conventional rotating disk in an unbalance condition.

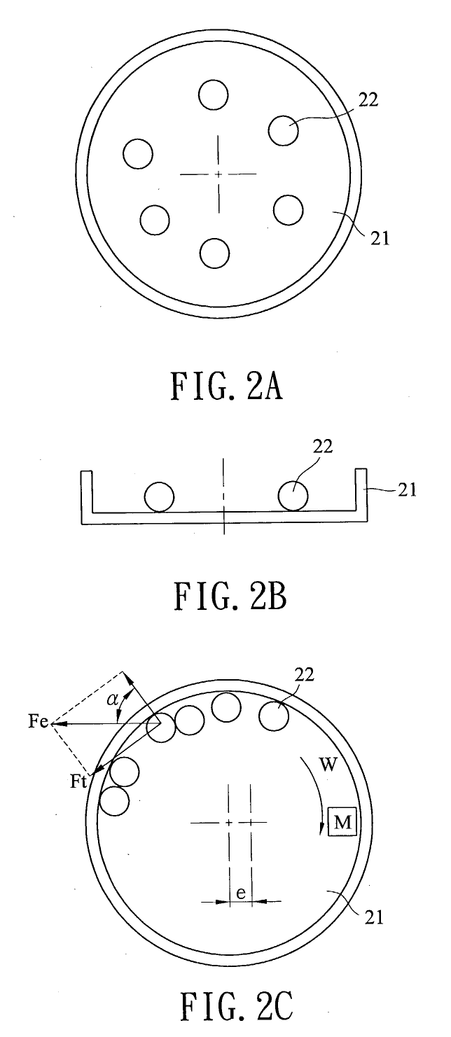

FIGS. 2A, 2B and 2C are schematic views of the invention showing the automatic balance principle.

FIGS. 3A-3C are schematic views of the invention, showing balance processes.

FIGS. 4A-4D are schematic views of the invention.

FIG. 5 is a schematic view of the invention, showing a balance structure.

FIGS. 6A and 6B are schematic views of an application of the invention.

### DESCRIPTION OF THE PREFERRED EMBODIMENTS

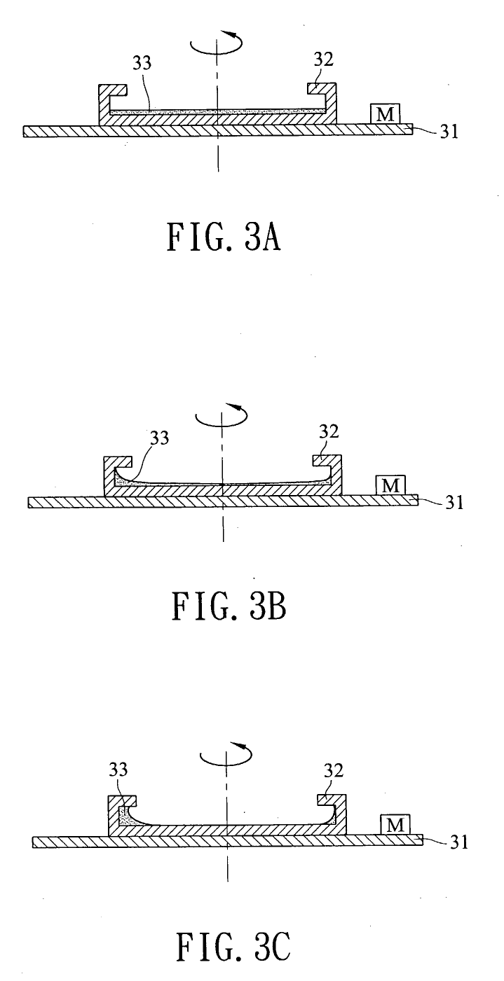

Refer to FIGS. 2A and 2B for the anti-vibration method of rotating disks adopted for use on color wheel modules and rotating disks for eliminating vibration. As shown in the drawings, there is a container 21 with an unbalance substance M. The container 21 further holds a plurality of steel balls 22. When the container 21 rotates at a selected angular speed ω (referring to FIG. 2C), the unbalance substance M incurs a vibration displacement e due to the centrifugal force. The vibration displacement e generates a force Fe (Fe=meω² where m is the substance of the steel balls) on the steel balls 22. The component force Ft (Ft=Fe* cos (α), where α is the included angle against the radial direction) of the force Fe in the tangential direction moves the steel balls 22 along the perimeter direction opposite to the unbalance substance M until reaching a balance condition. Due to the friction between the steel balls 22 and the container 21, it is difficult for the steel balls 22 to reach a completed balance condition. As fluid does not have friction problem, the curable fluid can replace the steel balls 22 to attain a completed balance condition.

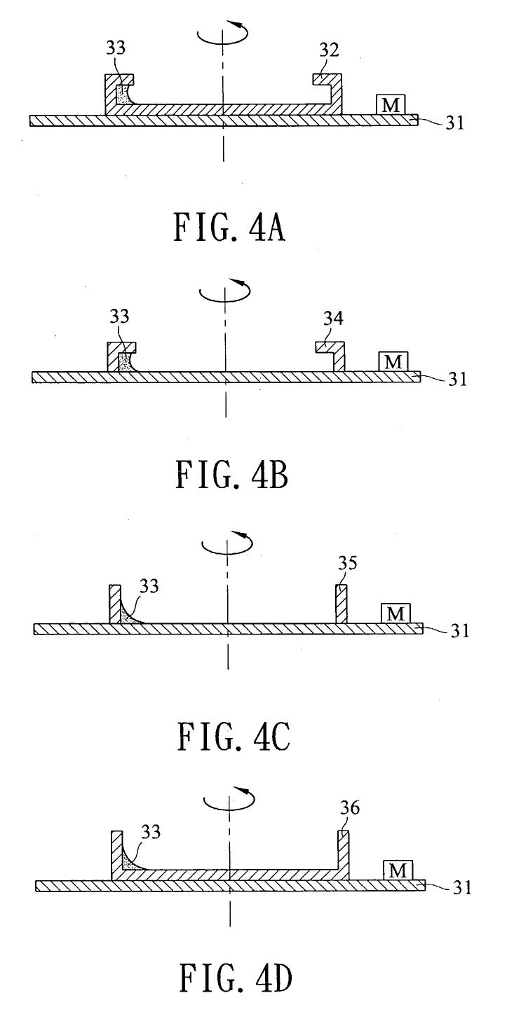

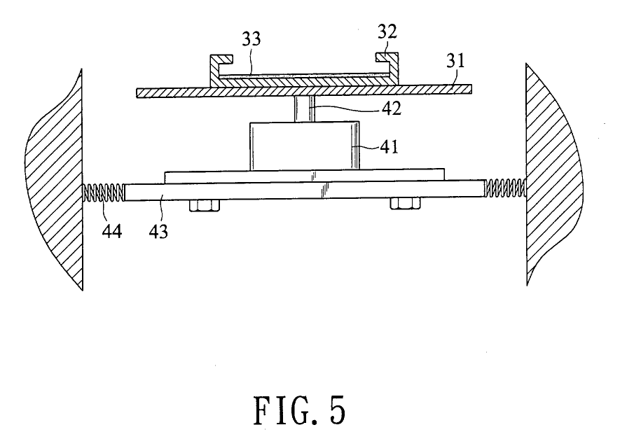

Refer to FIG. 3A for an embodiment of the invention adopting the principle set forth above. There is a rotating disk 31 with a bowl 32 located thereon to form a holder for containing curable fluid 33. In the event that an unbalance substance M is located on one side of the rotating disk 31, according to the principle set forth above, the fluid 33 is subject to the vibration force and flows along the perimeter direction to the other side, but will be held in the holder due to the constraint of the side wall of the holder (as shown in FIG. 3B). Refer to FIG. 4A for an example. The unbalance substance M is located on the right side, so the fluid 33 finally accumulates on the left side of the bowl 32 (as shown in FIG. 3C). In an ideal condition, all of the fluid is totally accumulated on the left side (as shown in FIG. 4A). However due to viscosity and surface tension and centrifugal force, the actual fluid distribution is like that shown in FIG. 4C. In such a condition, the fluid substance accumulated on the left side offsets the unbalance substance M on the right side, the rotating disk 31 reaches a balance condition, and the vibration caused by unbalance can be prevented. Once the balance condition is attained, the fluid 33 is curdled and solidified. The distributed state may be fixed to maintain a permanent balance condition.

Furthermore, the application of FIG. 2A to FIG. 3D can be combined because it run under same principle. The steel balls can be put into the above-mentioned fluid to enhance the capability of reducing the mass unbalance.

Compared with the conventional methods, using fluid 33 to achieve balance distribution not only saves the time of the trial and error process, but the balance condition is also more precise. The curable fluid 33 may be selected from photosensitive curable fluid (such as UV gel), thermal sensitive curable fluid or double agent curable gel. The curing of the fluid 33 may be done by providing photo energy, thermal energy, catalysts or the like. It is to be noted that the curable fluids and curing methods mentioned above are only to serve as examples; other types of curable fluid may also be selected as desired.

FIG. 4A illustrates an embodiment of the holder that is formed by mounting a bowl 32 onto a rotating disk 31. The mounting process can be accomplished by adhering, screwing, coupling, latching or other fastening means known in the prior art. In order to prevent the fluid 33 from spilling out during rotating, an extended flange may be formed on the top edge of the side wall of the bowl 32. Of course an annular element 34 may also be used (as shown in FIG. 4B) to mount onto the rotating disk 31 to form the holder on the rotating disk 31 to contain the fluid 33. On the other hand, when the amount of the fluid 33 is not much, or the bowl 36 and the annular element 35 have a higher side wall, the extended flange may be dispensed with (referring to FIGS. 4C and 4D).

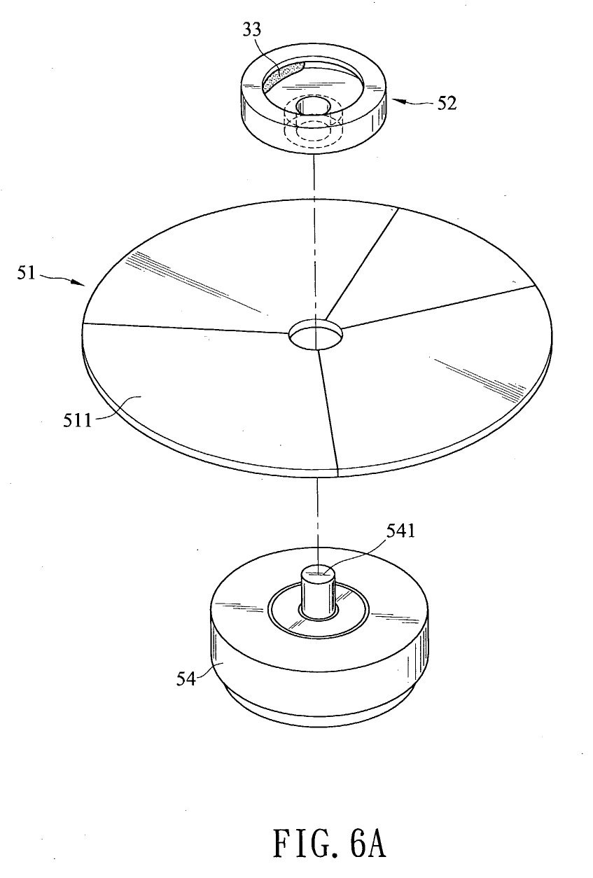

For performing balance in practical situations, the rotating disk 31 may be mounted onto a spindle 42 of a motor 41 and driven to rotate. Similarly, in order to prevent interference or inaccurate measuring, a suspending board 43 supported by springs 44 may be used to anchor the whole structure as shown in FIG. 5.

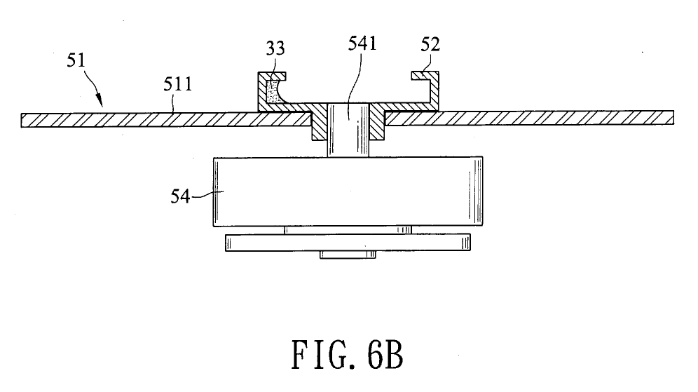

Refer to FIGS. 6A and 6B for the invention adopted on a color wheel module. The color wheel module consists of a motor 54, a spindle 541, a holder 52 and a color wheel 51. The motor 54 drives the spindle 541 to rotate. The holder 52 is formed on the inner peripheral rim of the color wheel 51 and is coaxial with the color wheel 51. Moreover, the holder 52 and the color wheel 51 are coupled together and are tightly mounted onto the spindle 541 and driven by the motor 54 for rotating.

The holder 52 is bonded to the inner peripheral rim of the color wheel 51. The bonding method may be direct adhesion or the like. The holder 52 may be formed in any one of the embodiments set forth above (bowl, annular element, etc.) to contain the curable fluid 33. In addition, the color wheel 51 consists of a plurality of transparent color filter films 511 to modulate and change the color of the light beams passing through. The color filter films 511 mostly include red, green, blue and white colors. They are respectively formed in a fan shape to couple together to form the circular color wheel 51.

Once the holder 52 is bonded to the color wheel 51, balance may be performed independently. Balance may be achieved by the method set forth above, and by means of the apparatus shown in FIG. 5. After balance is attained, the holder 52 is mounted onto the spindle 541, which is driven by the motor 54 to modulate the color of the light beams alternately. On the other hand, it is also allowable to mount the holder 52 and the color wheel 51 on the spindle 541, then perform balance and curing. This may be done because fluid curing does not affect the original precision after balance is achieved.

In summary, the anti-vibration method for rotating disks and its apparatus for color wheels and rotating disks of the invention employs fluid to reach balance positions and distribute under high speed rotation, then uses the curing characteristics to solidify the fluid. Thus balance is easier to achieve and more precise.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An anti-vibration method of rotating disks for eliminating vibration of a rotating disk resulting from unbalance, comprising steps of:
forming a holder on the rotating disk;
filling a selected amount of a curable fluid in the holder;
rotating the rotating disk until the rotating disk reaching balance such that the fluid flows towards the perimeter direction of the rotating disk due to a vibration force resulting from the rotation of the rotating disk, the fluid being retained by a side wall of the holder without escaping; and
curing the curable fluid.

2. The method of claim 1, wherein the holder is formed by an annular element or a bowl bonding to the rotating disk.

3. The method of claim 2, wherein the annular element or the bowl is bonded by a means selected from the group consisting of adhering, screwing, latching and coupling.

4. The method of claim 1, wherein the curing of the curable fluid is selected from a group of approaches consisting of providing photo energy, providing thermal energy and providing catalysts.

5. The method of claim 4, wherein the curable fluid is selected from a group of fluid consisting of a photosensitive curable fluid, a thermal sensitive curable fluid and a double agent curable gel.

6. The method of claim 1, wherein the holder and the rotating disk are coaxial.

7. An anti-vibration method of rotating disks for eliminating vibration of a rotating disk resulting from unbalance, comprising steps of:
forming a holder on the rotating disk;
filling a selected amount of a curable fluid and some round shape ball in the holder;
rotating the rotating disk until the rotating disk reaching balance such that the fluid and the ball flows towards the perimeter direction of the rotating disk due to a vibration force resulting from the rotation of the rotating disk, the fluid and the ball being retained by a side wall of the holder without escaping; and
curing the curable fluid.

8. The method of claim 7, wherein the holder is formed by an annular element. or a bowl bonding to the rotating disk.

9. The method of claim 8, wherein the annular element or the bowl is bonded by a means selected from the group consisting of adhering, screwing, latching and coupling.

10. The method of claim 7, wherein the curing of the curable fluid is selected from a group of approaches consisting of providing photo energy, providing thermal energy and providing catalysts.

11. The method of claim 10, wherein the curable fluid is selected from a group of fluid consisting of a photosensitive curable fluid, a thermal sensitive curable fluid and a double agent curable gel.

12. The method of claim 7, wherein the holder and the rotating disk are coaxial.

13. An anti-vibration apparatus of rotating disks for eliminating vibration of a rotating disk resulting from unbalance, comprising:
a motor for providing rotation power;
a spindle housed in the motor and coupled with the rotating disk for transmitting the rotation power to the rotating disk to drive the rotating disk to rotate;
a holder formed on the rotating disk; and
a curable fluid contained in the holder;
wherein the motor provides the rotation power which is transmitted to the rotating disk through the spindle, the fluid in the rotating disk flowing to the perimeter side of the holder under a vibration force and being retained by a side wall of the holder without escaping such that the fluid is distributed in such a way to balance the rotating disk, and the fluid being cured after the balance is attained.

14. The anti-vibration apparatus of claim 13, wherein the holder is formed by an annular element or a bowl bonding to the rotating disk.

15. The anti-vibration apparatus of claim 13, wherein the curable fluid is selected from a group of fluid consisting of a photosensitive curable fluid, a thermal sensitive curable fluid and a double agent curable gel.

16. The anti-vibration apparatus of claim 15, wherein the curing of the curable fluid is selected from a group of approaches consisting of providing photo energy, providing thermal energy and providing catalysts.

17. The anti-vibration apparatus of claim 13, wherein the holder has a flange located on a top end of the side wall thereof and extended inwards.

18. The anti-vibration apparatus of claim 13, wherein the holder and the rotating disk are coaxial.

19. An anti-vibration color wheel module for modulating the color of an external incident light through a rotation method, comprising:
a spindle;
a motor for driving the spindle to rotate;
a color wheel having a plurality of transparent colored filter films to be driven to rotate by the spindle to alternately module the color of the incident light;
a holder formed on an inner perimeter rim of the color wheel; and
a curable fluid contained in the holder, the fluid in the holder flowing to the perimeter side of the holder under a vibration force and being retained by a side wall of the holder without escaping such that the fluid is distributed in such a way to balance the rotating disk, and the fluid being cured after the balance is attained.

20. The anti-vibration color wheel module of claim 19, wherein the curable fluid contained in the holder balances the color wheel through an external rotation power and is cured after the balance is attained.

21. The anti-vibration color wheel module of claim 19, wherein the curable fluid is selected from a group of fluid consisting of a photosensitive curable fluid, a thermal sensitive curable fluid and a double agent curable gel.

22. The anti-vibration color wheel module of claim 21, wherein the curing of the curable fluid is selected from a group of approaches consisting of providing photo energy, providing thermal energy and providing catalysts.

23. The anti-vibration color wheel module of claim 21, wherein the holder and the rotating disk are coaxial.
